(19) United States
(12) Patent Application Publication
(10) Pub. No.: US 2003/0231748 A1
(43) Pub. Date: Dec. 18, 2003

(54) System and method for quietly answering an incoming communication

(76) Inventor: David Novelline, Chelmsford, MA (US)

Correspondence Address: SLATER & MATSIL, L.L.P., 17950 PRESTON RD, SUITE 1000, DALLAS, TX, 75252-5793, US

(21) Appl. No.: 10/173,953

(22) Filed: Jun. 18, 2002

(51) Int. Cl. H04M 1/64

(52) U.S. Cl. 379/88.23

(57) ABSTRACT

The present invention includes a method for minimizing disruption when a user receives a communication (e.g., phone call) from a caller. In an embodiment of this method, an incoming communication is detected. The incoming communication is answered with a greeting informing the caller that the user can only respond with a pre-selected set of responses. After receiving a message from the caller, the user provides an indication selecting one of the possible responses to be communicated to the caller. The selected response is then communicated to the caller.

### TECHNICAL FIELD

The present invention relates generally to a system and method for answering an incoming communication, and more particularly to a system and method for quietly answering the incoming communication.

### BACKGROUND

The use of wireless telephones is becoming increasingly prevalent due to their convenience. However, this prevalence of wireless telephones can create disturbances in various situations due to the ringing of the wireless telephones. In an effort to minimize these disturbances, manufacturers now fabricate wireless telephones having a vibrating mode to alert a user of an incoming telephone call. The user may either answer the call or allow the call to rollover into a voicemail answering system. If the user answers the incoming call, the user's voice disrupts those nearby, or the user must be excused and answer the incoming call in another location, possibly creating a disruption by leaving.

In many situations, verbally answering a call or being excused to answer a call is unacceptable. Such situations might include business meetings, concerts, theaters or classes. However, it may be equally unacceptable to let an incoming telephone call rollover to the voicemail answering system. This can occur when an executive is in a business meeting for a first project but must make an urgent decision on a second project. Another example is when parents leave their children in the care of a babysitter, who must be able to reach the parents, who may be attending a concert, in the case of an emergency. These are but some of the myriad of circumstances where it is desirable to respond in some manner to incoming calls, particularly voice calls.

### SUMMARY OF THE INVENTION

These and other problems are addressed, and technical advantages are achieved, by preferred embodiments of the present invention that allow the user of a wireless telephone to quietly and discretely respond to incoming telephone calls. By allowing the user to quietly and discretely respond to incoming telephone calls, the user need not disrupt those nearby, and the confidentiality associated with the content of the communication can be preserved.

In accordance with a first embodiment of the present invention, a method for minimizing disruption when a user answers a communication device is disclosed. The method comprises detecting an incoming communication and answering the incoming communication with a prerecorded greeting informing a caller that the user can only answer questions having a pre-selected set of possible responses. The user then communicates with the caller by answering a caller's question by pressing a first button on the communication device to provide a first one of the pre-selected set of possible responses and by pressing a second button on the communication device to provide a second one of the pre-selected set of possible responses.

In accordance with a second embodiment of the present invention, a communication device that minimizes disruption when a user answers it is disclosed. The communication device includes a means for detecting an incoming communication and means for providing information to the user corresponding to the incoming communication. The communication device further comprises a controller and a keypad, the controller being coupled to the means for detecting and the means for providing information. The controller answers the incoming communication with a prerecorded greeting informing a caller that the user can only answer questions having a pre-selected set of possible responses. The user then communicates with the caller by answering a caller's question by pressing a first key on the keypad to provide a first one of the pre-selected set of possible responses and by pressing a second key on the keypad to provide a second one of the pre-selected set of possible responses

An advantage of the preferred embodiments of the present invention is that it minimizes the distraction created by the ringing of a communication device at an inopportune time, such as a meeting, at the theater or in class.

A further advantage of the preferred embodiments of the present invention is that it allows the user to communicate without requiring vocal responses, which may be disruptive to those around the user.

A further advantage of the preferred embodiments of the present invention is that practice of the invention allows for the preservation of confidentiality of the communication between communicants, at least with respect to the call environment with which the call recipient is associated at the time of the call.

Yet another advantage of embodiments of the present invention is that others can contact the user in the case of an emergency without fear of disrupting a meeting, etc., to the embarrassment of the user.

The foregoing has outlined rather broadly the features and technical advantages of the present invention in order that the detailed description that follows may be better understood. Additional features and advantages of the invention will be described hereinafter, which form the subject of the claims of the invention. It should be appreciated by those skilled in the art that the conception and specific embodiments disclosed might be readily utilized as a basis for modifying or designing other structures or processes for carrying out the same purposes of the present invention. For example, features and functionality of the invention can be implemented at one or both of a call recipient's mobile terminal, the call network switch or other such network component, or shared between a mobile terminal and an appropriate network component. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, and the advantages thereof, reference is now made to the following descriptions taken in conjunction with the accompanying drawings, in which:

FIG. 1 is an overview of a wireless telephone that can incorporate an embodiment of the present invention; and

FIG. 2 is a flowchart of an embodiment of the present invention.

### DETAILED DESCRIPTION

A method and a system for implementing the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. For example, features and functionality of the invention can be implemented at one or both of a call recipient's mobile terminal, the call network switch or other such network component, or shared between a mobile terminal and an appropriate network component.

The present invention will be described with respect to preferred embodiments in a specific context, namely a wireless mobile terminal, such as a wireless mobile telephone. The invention may also be applied, however, to other communication systems that require a quiet response to requests for information. Such systems may include corded telephones, wireless pagers, two-way radios, personal digital assistants and the like. For this reason, the description will use such terms as “call” for the more general concept of “communication” and “caller” for the one who initiates a “communication.” Moreover, the invention as concerns wireless mobile terminals is applicable independent of air interface standard. As such, the invention is applicable in various time-, code- and/or frequency-division access standards, such as may be standardized by the TIA as digital standard IS-95, the ITU's cdma2000 digital cellular standards, the 1xEV-DO (specified as 3GPP2 as HRPD and standardized as TIA IS-856), UMTS/W-CDMA, GSM, and the like.

The preferred embodiment of the invention provides a privacy function on a wireless telephone. As an example, the preferred embodiment would be useful for a person who constantly needs to make decisions but cannot always talk. A specific example can be used to understand the value of this embodiment. As will be discussed below, the present invention is broader than the implementation of this one example.

Assume for this example that a busy executive is in a meeting but has several other matters that need her attention. The executive's wireless telephone “rings” in silent mode, such as by way of a vibration alert, and the executive, who may optionally be connected to the wireless telephone by a hands-free device such as an earpiece, reaches down to the phone and activates an Answer/Quiet feature. This feature activates a message that states something to the effect of, “I am available but in a situation where I cannot speak. I can, however, answer a yes or no question via my telephone. Please proceed and ask me your questions.” Depending on the capabilities of the wireless telephone and/or wireless network, the outgoing message could optionally be in the form of a pre-recorded message of the wireless telephone's principal user.

The phone and/or network component, in turn, would be equipped with a function to respond with an audible, “yes,” “no,” or perhaps other pre-selected responses, such as antonym pairings (“right/left”, “up/down”, “increase/decrease”, and the like). The caller would then ask questions and the user (e.g., the executive in this example) would answer by selecting the appropriate response. For example, pressing the “1” key could cause a message to speak “yes”; pressing the “2” key could cause “no;” and pressing the “3” key could cause “good-bye.”

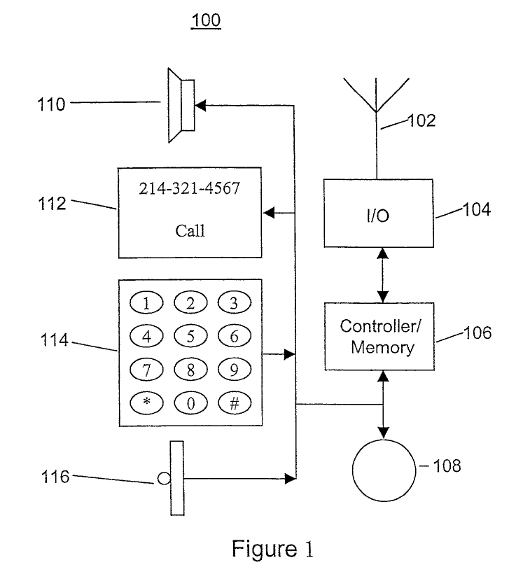

FIG. 1 shows an example of a wireless telephone 100 that could be used to implement this procedure. The wireless telephone 100 includes an antenna 102, a signal processing section 104, a controller unit 106, a vibrator 108, an optional hands-free device, such as earpiece 1 10, an alphanumeric display panel 112, a keypad 114, and a microphone 116. Incoming calls received by the antenna 102 are demodulated and otherwise processed in a manner well known in the wireless communications field by the signal processing section 104 for handling in the mobile terminal, and provided to the controller unit 106. The controller unit 106 may also receive data from the keypad 114 and/or the microphone 116. The controller unit 106 may cause data to be displayed on the alphanumeric display panel 112 or sounds (e.g., a caller's voice) to be output to the earpiece 110.

While the controller unit 106 is illustrated as a single element, the controller 106 may include internal memory or have a separate memory. These elements can be included in a single integrated circuit chip or spread over a number of chips. While term “controller” is used, it is understood that any circuit that controls or otherwise manages operation of the device 100 could be implemented. For example, a digital signal processor (DSP) may also be used as the controller unit 106. Similarly, the controller could be implemented in a state machine embodied in an ASIC (application specific integrated circuit). The controller 106 and processing section 104 can further be implemented in a single chip.

FIG. 1 illustrates a call reception indication device in the form of a vibration component 108 that can be used to notify the user of an incoming call. The vibration component is oftentimes provided in addition to the conventional audible alert (i.e., “ringing”) device typically associated with wireless telephones, and is typically established as a user-selectable feature through controller 106 in accordance with appropriate keypad input. In the preferred embodiment, the incoming call notification method would be silent (or very quiet—a vibration device is not completely silent) but this is not a requirement. As an example, the vibration device 108 could be replaced with, or supplemented by, visual indicia, such as illumination of the keypad, display, or the like. As another example, the vibration device 108 could be replaced with, or supplemented by, a mechanism that causes the earpiece 110 to ring. Alternatively, the earpiece 110 itself could be configured to vibrate to signify the existence of an incoming call.

The user input/output portions shown in FIG. 1 are provided to illustrate the input/output of a commonly used wireless telephone. In other words, with a cellular phone the user provides information to the device 100 with a data input such as a keypad 114 and microphone 116 and receives information from the device via an earpiece 110 and display 112. These particular elements (110, 112, 114, and 116) are provided as examples intended to broadly illustrate the concept the manner in which the user somehow interacts with the communication device 100, be it for the entry of data generally, or for the entry of inputs related to the establishment or management of a call session. For example, display 112 could include an LCD (liquid crystal display) or any other suitable means of displaying alphanumeric data. Alternatively, the display 112 could be eliminated altogether (e.g., where the information is spoken to the user). As another example, FIG. 1 illustrates a data entry numeric keypad 114. Alternatively, the device 100 could be configured to include a full alphabet (or alpha-numeric) data input device or keypad 114 or no keypad at all (e.g., in the case of a voice recognition system).

The earpiece 110 can be integrated into the device 100. More preferably, however, the earpiece 110 is configured to fit adjacent the user's ear. For example, if the device 100 can be a standard wireless telephone to which an earpiece 110 has been added. The connection of the earpiece 110 preferably disconnects the integrated speaker so that all incoming calls are heard on the earpiece 110 and not the integrated speaker.

The microphone 116 is preferably included so that the user can speak with others. During the use of the preferred embodiment, however, the microphone 116 is not used and therefore can be eliminated. An example of a device 100 that does not include a microphone 116 is a PDA that allows a pre-selected set of responses, which, for example, could be selected by the using touching (with a finger or stylus) selected portions of the display or pushing selected buttons. Alternatively, the device 100 could have a user-selectable switch (not shown) to deactivate the microphone, as may be beneficial when combined earpiece/microphone devices are used with the terminal 100

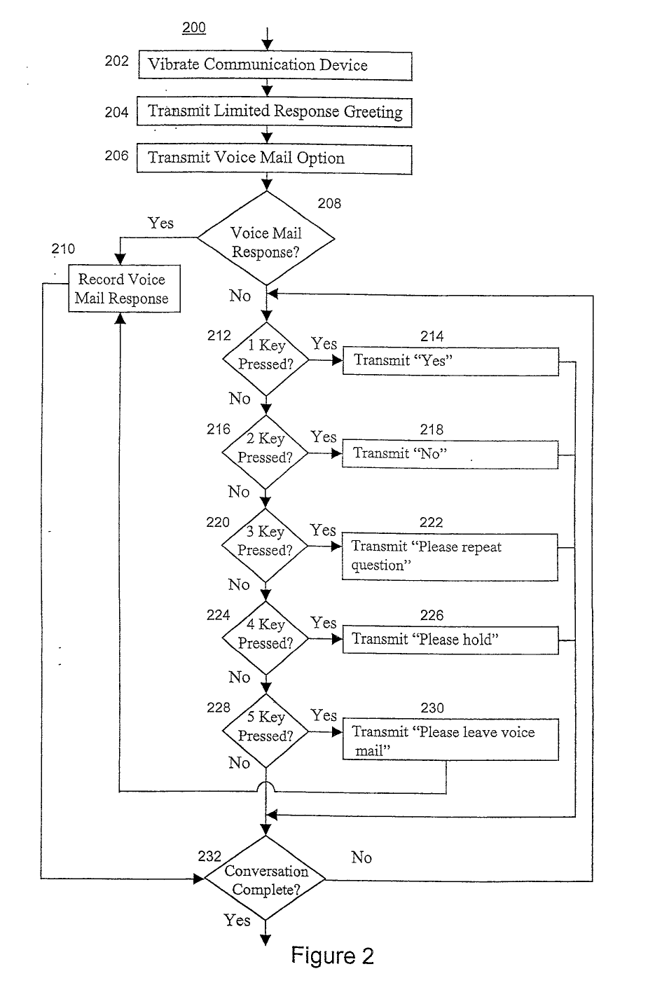

FIG. 2 shows an example of a method 200 by which the wireless telephone 100 operates to allow for a quiet response to an incoming call. In this discussion, a user is the person associated with the communication device 100 and a caller is a person that attempts to communicate with the user via the communication device 100.

To activate the method 200, the user can place the wireless telephone 100 in the quiet response mode, e.g., when entering a meeting, the theater, a classroom, a church, or other. Alternatively, the user can view an incoming call, e.g., using a caller ID function, to determine whether he wishes to enter quiet response mode. If not, he can either answer the call or allow it to go to voice mail (or be forwarded or go unanswered in accordance with a desired option ).

Upon receipt of an incoming call, the wireless telephone 100 detects the incoming communication and notifies the user. For example, block 202 indicates that the phone would vibrate or otherwise indicate to the user that an incoming call has been received. As discussed above, other methods of notification can be used. When the wireless telephone 100 is in quiet response mode it automatically responds to the incoming call by transmitting a limited response greeting as shown by block 204. This greeting can indicate that the user is unavailable for a conversation, but can respond to questions requiring one of a pre-selected set of possible responses.

As indicated by block 206, the caller can also be given the option to record a voice mail rather than using the limited response system. If the caller selects the voice mail option (block 208), the voice mail function will be activated as indicated by block 210. The caller can then leave a voice mail and the communication would be terminated or continue to another stage.

Blocks 212-230 are provided to indicate one example of responses that can be provided. For example, the pre-selected possible responses can include: “yes” (block 214), “no” (block 218), a request for the caller to repeat the last question (block 222), a request for the caller to hold while the user moves to a location where audible communication is possible (block 226), and a request for the caller to leave a message (block 230). The remainder of this example will utilize this set of possible responses.

As should be clear, the number and substance of possible responses is numerous. For example, by utilizing two key selections per response, one hundred possible responses could be activated. In the preferred embodiment, however, the number of responses is held to less than ten so that the user can keep track of the choices rather easily.

The actual responses, e.g., what the caller hears, can be pre-recorded by the user (or someone else at the direction of the user) or can be provided by the service provider. In the preferred embodiment, the service provider would provide a pre-recorded set of responses or possibly a library of responses from which the user can choose some or all. The user would also be given the opportunity to provide personalized responses, for example by recording a selected message to be played in response to pressing a specific key. This would allow the caller to hear the user's voice in response to the caller's speaking.

Blocks 212, 216, 220, 224 and 228 are associated with specific buttons on the numeric keypad that would translate into one of the pre-selected responses. If the caller chooses to use the system in block 208, he would speak to the caller and the speech (e.g., question) will be heard by the user on the earpiece 110 and/or displayed on the alphanumeric display panel 112. In response to a question, if the user presses the “1” key on the keypad 114, as shown by block 212, the controller 106 will generate a “yes” response that is transmitted to the caller in step 214. If the user presses the “2” key, as shown by block 216, the controller 106 will generate a “no” response that is transmitted to the caller, as shown by block 218.

While simple “yes” and “no” responses would be the simplest implementation of the present invention, it is preferable that additional pre-selected possible response options be provided. Examples of such additional options are shown in the remainder of FIG. 2. For example, if the question by the caller was unclear or the user's surroundings were loud, the user can press the “3” key, as shown in block 220, and the controller 106 will cause transmission of a message to the caller such as “please repeat the last question” (block 222). Further, “custom” responses can be pre-established by the user in anticipation of a specific call at a time during which the user would desire to activate the “quiet response” mode.

Upon hearing the question, the user may determine that a simple “yes” or “no” answer is insufficient. Under these circumstances, the user can press “4” (block 224) and the controller 106 will cause transmission of a message to the caller such as “please hold while I move to a location where I can speak,” as shown by block 226. Alternatively, the user may want the caller to leave a voicemail message rather than ask “yes”/“no” questions. In this case, the user can press “5” as shown in block 228. Pressing “5” will cause the controller 106 to transmit a “please leave a voicemail” message (block 230) and record the voicemail message, as shown by block 210.

Once the appropriate message has been sent to the caller, the controller 106 will determine if the conversation is complete, as shown by block 232. The controller 106 may determine this by sensing if the caller is still on the line or has hung up. Alternatively, this determination may be made based on the user pressing a given key such as “0” or “#” or “*”. If the conversation is not complete, the user will hear the next question and can respond by pressing a key as before.

It is noted that while the above description assigned the “1” key to “yes,” this assignment is completely arbitrary. As an alternative, the “9” key may be used to denote “yes” as “y” is found on the “9” key, while the “6” key may be used to denote “no” as “n” is found on the “6” key. Alternatively, more than one key can be used to indicate a single response. For example, pressing a key on the top row of the keypad could be used to indicate a “yes” and pressing a key on the bottom row of the keypad could be used to indicate a “no.” This feature would be useful to assist a user than cannot see the keypad (e.g., in a dark auditorium).

Further, while a total of five possible responses are illustrated in the pre-selected set of possible responses described above, these responses are meant to be illustrative only. Alternative answers in the set of pre-selected set of possible responses could indicate degrees of agreement or disagreement by assigning “I strongly agree” to the “1” key down to “I strongly disagree” to the “5” key. Another possible answer is “I will call back in 10 minutes.” Far more responses are possible and the set of pre-selected set of possible responses is only limited by the complexity required in entering the response or by the user remembering the set of pre-selected set of possible responses.

The controller 106 may cause the greetings and responses in the set of pre-selected set of possible responses to be generated by a voice synthesizer. Alternatively, the greetings and responses may be stored in a memory internal to or associated with the controller 106. More likely, the greetings and responses would be stored in a system operated and controlled by the service provided in a method similar to voice mail. In either case, the controller 106 would cause these greetings and responses to be communicated to the caller.

Thus, although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, means, methods and steps described in the specification. As one of ordinary skill in the art will readily appreciate from the disclosure of the present invention, processes, machines, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, means, methods, or steps.

What is claimed is:

1. A method for minimizing disruption when a user receives a communication from a caller via a communication device, the method comprising:
detecting an incoming communication;
answering the incoming communication with a greeting informing the caller that the user can only respond with a pre-selected set of possible responses;
transmitting a message from the caller to the user;
receiving an indication from the user, the indication selecting one of the possible responses; and
causing the selected one of the responses to be communicated to the caller.

2. A method in accordance with claim 1, further comprising providing a non-audible indication to the user in response to detecting the incoming communication.

3. A method in accordance with claim 2, wherein providing a non-audible indication comprises causing the communication device to vibrate.

4. A method in accordance with claim 1, wherein answering the incoming communication further comprises giving the caller an option to record a message for the user.

5. A method in accordance with claim 1, wherein the pre-selected set of possible responses includes a response indicative of one of at least two antonyms.

6. A method in accordance with claim 5, wherein the pre-selected set of possible responses further includes requesting the caller to repeat the last question.

7. A method in accordance with claim 5, wherein the pre-selected set of possible responses further includes requesting the caller to hold while the user moves to a location where audible communication by the user is possible.

8. A method in accordance with claim 5, wherein the pre-selected set of possible responses further includes requesting the caller to leave a voice message.

9. A method in accordance with claim 1, wherein receiving an indication from the user comprises receiving an indication that the user pressed a button on the communication device.

10. A communication device operable to minimize disruption during operation by a user, the communication device comprising:
a keypad; and
a controller coupled to receive user input from the keypad and to cause audio communications to be transmitted, the controller translating user input from the keypad to cause one of a pre-recorded set of audible-speech responses to be transmitted.

11. A communication device in accordance with claim 10, further comprising means for notifying the user of an incoming communication.

12. A communication device in accordance with claim 11 wherein the controller answers the incoming communication with a greeting informing a caller the user can only answer with a limited set of responses.

13. A communication device in accordance with claim 10, wherein the pre-recorded set of responses includes a response indicative of one of at least two antonyms.

14. A communication device in accordance with claim 10, wherein the communication device comprises a wireless voice and/or data terminal.

15. A wireless mobile terminal, comprising:
a device operable to generate physical input to a user to notify a user of an incoming communication;
a speaker;
a controller operable to generate an output to a caller indicating that the user can interact with the caller through the selection of prescribed outgoing responses; and
a keypad coupled to the controller and operable to receive user inputs corresponding to at least one of the prescribed outgoing responses.

16. The wireless telephone of claim 15 and further comprising:
a microphone coupled to the controller; and
a display coupled to the controller.
